(19) United States
(12) Patent Application Publication
(10) Pub. No.: US 2019/0353583 A1
(43) Pub. Date: Nov. 21, 2019

(54) POLARIZED LIGHT MATERIAL INSPECTION TOOL

(71) Applicant: UES, Inc., Dayton, OH (US)

(72) Inventor: Jonathan Cherry, Tipp City, OH (US)

(73) Assignee: UES, Inc., Dayton, OH (US)

(21) Appl. No.: 16/416,146

(22) Filed: May 17, 2019

Related U.S. Application Data
(60) Provisional application No. 62/673,725, filed on May 18, 2018.

(51) Int. Cl. G01N 21/21

(52) U.S. Cl. CPC G01N 21/21; G01N 2201/0221

(57) ABSTRACT

The invention relates to a portable material inspection device, with a light source, a polarizer, and an analyzer. The light source emits light through the polarizer to a material and the light reaches the analyzer. The angle or position of the incident emitted light, either polarized or unpolarized is freely adjustable. The inspection device may have an waterproof and dust resistant external shell and be relatively small, less than 7 inches by 5 inches by 2 inches.

### CROSS REFERENCE TO RELATED APPLICATIONS

The present application claims the benefit of priority to U.S. Provisional Patent Application 62/673,725, filed May 18, 2018 with first named inventor Jonathan Cherry.

### BACKGROUND

### Field of the Invention

The present invention relates to a material inspection tool and a material detection method, and more specifically to a material inspection tool and method using polarized light.

### Description of the Related Art

In the field of material inspection, the current state of the art for material inspection is the use of electron backscatter diffraction in a scanning electron microscope (SEM). In an SEM, a focused beam of electrons is directed towards a surface, the electrons interact with the material, and the resulting energy spectra created by the electron-material interaction are recorded by the SEM or accompanying detectors.

For a standard SEM, a specimen must be prepared before being inspected, as exemplified in British Patent GB2105485B issued to the University of Leicester. The specimen size is limited by the geometry of the SEM itself, and therefore often requires that the specimen to be cut or sectioned from the bulk material or item to be studied. This requirement limits the use of SEMs from inspecting materials or items which may still need to be used, as the removal of any part of the material of an item may render the item useless or less effective.

In certain SEMs, the specimen must be dried, etched or otherwise prepared. Again referring to the GB2105485B patent, the specimen is dehydrated and clamped to a surface before inspection is performed. To maintain the ability to monitor the signals from the electron-material interaction, the SEM and detectors operate in a vacuum or other clean environment. The requirement to bring a specimen or sample into the SEM precludes any ability to inspect materials in the current environment, whether that be indoors or outdoors. This preparation is costly, time intensive, and may degrade or alter the properties of the material to be inspected. The material data collected therefrom is modified from its native or operational state and potentially less effective of reality if the material properties have been significantly modified.

Looking at the prior art and market requirements, the need exists for a material inspection tool that can be used on materials in the condition and location where they may be, sacrificing neither the item to be inspected nor the quality of the data to be received via inspection.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention relates to a portable material inspection device, comprising a light source, a polarizer, and an analyzer. The light source emits light through the polarizer to a material and the light then passes through the analyzer. The incident angle or vibrational azimuth of the light, either polarized or unpolarized as well as the rotational angle of the analyzer may be adjusted independent of the material position. The portable material inspection device therefore can be very small, in some embodiments less than 7 inches by 5 inches by 2 inches.

### BRIEF DESCRIPTION OF THE DRAWINGS

FIG. 1 is a side view of a polarized light assembly with a key.

FIG. 2 is a side view of another embodiment of a polarized light assembly.

FIG. 3 is a side view of another embodiment of a polarized light assembly.

FIG. 4 is a side view of another embodiment of a polarized light assembly.

FIG. 5 is a top view of the light source of the polarized light assembly of FIG. 4.

FIG. 6 is a side view of the light source of the polarized light assembly of FIG. 4.

FIG. 7 is a side cut-out view of another embodiment of a polarized light assembly.

### DETAILED DESCRIPTION

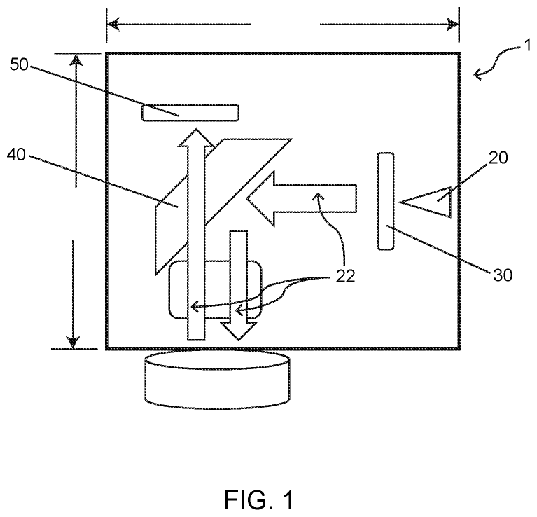

FIG. 1 provides a side view of a polarized light assembly 1 comprising a light source 20, a polarizer 30, a beam splitter 40, and an analyzer 50. The analyzer 50 may comprise a camera or other data capture device. The light source 20 may be any light source capable of adequately illuminating the material to be inspected.

The light source 20 provides light through the polarizer 30. The polarizer 30 may have a vibration azimuth which when the light 22 crosses through the polarizer 30 provides polarized light 22 in the direction of the beam splitter 40. The beam splitter 40 redirects the polarized light 22 through the objective to the material being inspected. The material may be any material, as the polarized light assembly 1 may be portable and brought to the material. Contemplated materials could be wood, metal, natural materials, flesh, bone, bio-material, composite material, fabrics, textiles, or any other material or combination of materials. The polarized light 22 interacts with the materials and reflects towards the analyzer 50. The analyzer 50 may comprise a vibration azimuth oriented in the same or a different angle in relation to the polarizer 30. In some embodiments, the vibration azimuths of the analyzer 50 and the polarizer 30 are at right angles to one another.

In providing the polarized light 22 between the polarizer 30 and the analyzer 50, the polarized light assembly 1 generates a privileged plane visible and thereby allows greater visibility of material characteristics of the material. Material characteristics which may therefore be derived from the acquired data may be material composition, tension, fatigue, stress, number and level of default, or any other characteristic inherent in a section of material. Of particular note would be the grain orientation, boundaries and crystallographic orientation and facets of the material, which would show areas of likely fatigue, flaws, and other material properties.

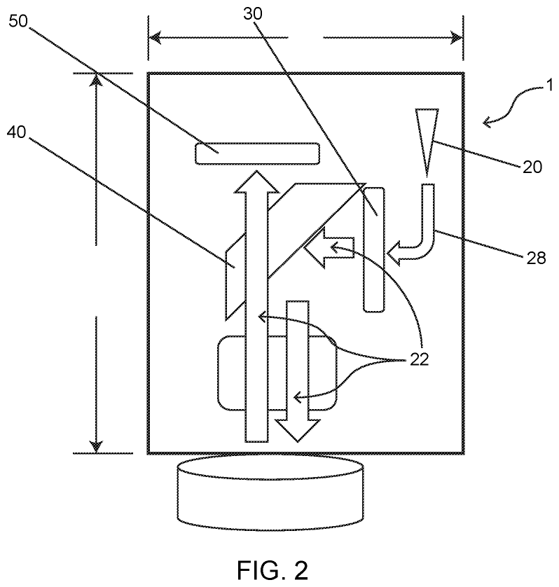

FIG. 2 shows another embodiment of the polarized light assembly 1 wherein the ability to move the light source 20 is further shown. The light from the distanced light source 20 may be conveyed to the device by a fiber optic or any other light transmission medium 28. In a preferred embodiment, the light source 20 transmission medium is able to be integrated into the device to enable the size of the device to be reduced to around 7 inches by 5 inch by 2 inch. This set of dimensions enables easier device manipulation during material inspection. Further, this set of dimensions allows easier travel to and from a material inspection site if necessary. Additionally, this set of dimensions allows the insertion of the polarized light assembly 1 into situations and environments otherwise unobtainable with the current state of the art. For example, a polarized light assembly 1 may be inserted into a vehicle engine and inspect the components for fatigue, failure, or flaw susceptibility.

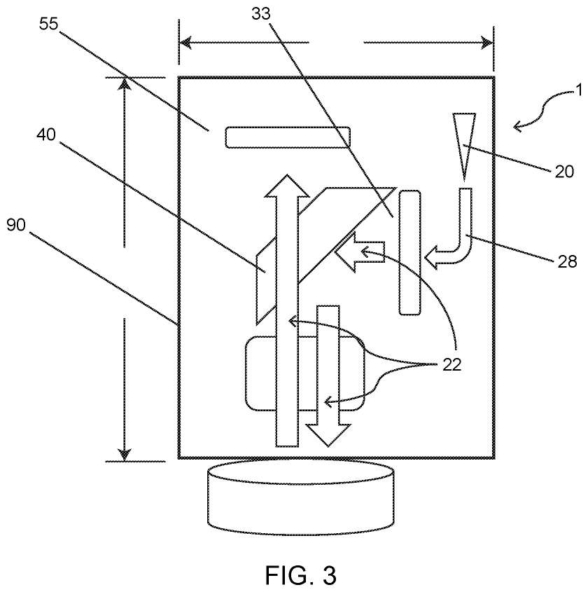

FIG. 3 shows an additional embodiment of the polarized light assembly 1 comprising a polarizer and mechanical or liquid crystal rotator 33. The polarizer and mechanical or liquid crystal rotator 33 may include an integrated polarizer 30 and mechanical or liquid crystal rotator. Alternatively, the polarizer and mechanical or liquid crystal rotator 33 may comprise an assembly whereby the polarizer and elements of a mechanical or a liquid crystal rotator are combined. The analyzer and mechanical or liquid crystal rotator assembly 55 may comprise an integrated analyzer 50 and mechanical or liquid crystal rotator. Alternatively, the analyzer and mechanical or liquid crystal rotator 55 may comprise an assembly whereby the analyzer and elements of a mechanical or a liquid crystal rotator are combined.

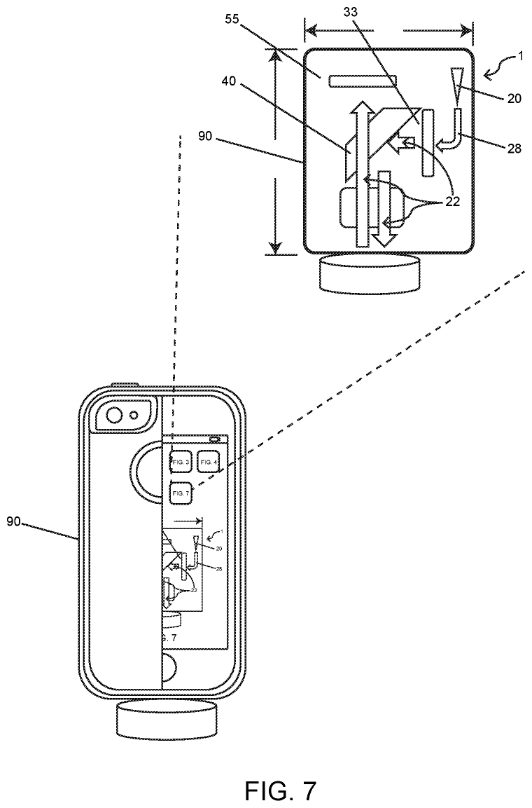

Embodiments such as those in FIGS. 1-3 may have an external shell or shell 90. The external shell 90 may encapsulate all or some of the polarized light assembly 1. The external shell 90 may be made of any material and may be transparent, opaque, or somewhere between. As shown in FIG. 7, the external shell 90 may be a protective shell similar to that used for ruggedized cell phones or laptops. The external shell 90 may be dust resistant, waterproof, heat resistant, or have any other qualities amenable to protecting the other elements of the polarized light assembly 1. The external shell 90 may be removable. Alternatively, the external shell 90 may be integrated into the rest of the polarized light assembly 1. In a preferred embodiment, all elements of the polarized light assembly 1 fit within an external shell 90 which has dimensions less than 7 inches by 5 inches by 2 inches.

In any of the above embodiments, the polarizer unit (30 or 33) and analyzer unit 50, 55 may be rotated in relation one to another from the original starting orientation of approximate perpendicularity. As with standard polarized light microscopy, as taught in U.S. Pat. No. 5,559,630, which is herein incorporated by reference, light 22 passes through the polarizer 30, 33 toward the material and either reflects off of or goes past the material and is collected at the analyzer 50, 55. The material being examined may exhibit anisotropic behaviors resulting in a change in the behavior of the polarized light.

By coupling the rotation of the polarizer (30 or 33) and analyzer 50, 55 by small incremental degrees and re-presenting polarized light 22 through the polarized light assembly 1, changes to the polarized light resented to the analyzer, can be achieved.

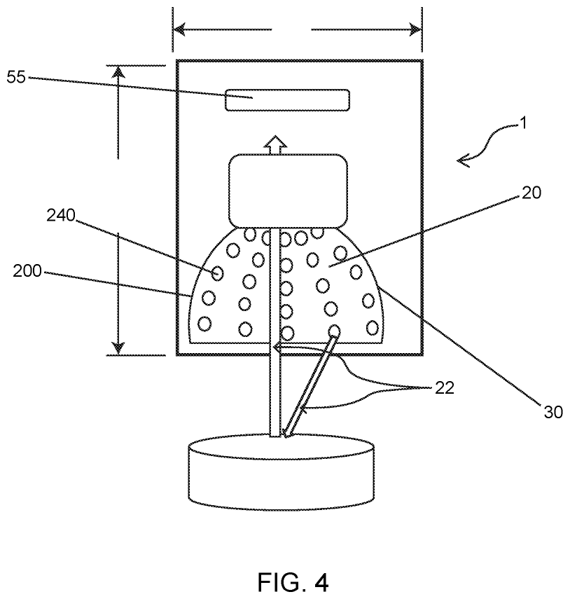

FIGS. 4-6 show another embodiment of the polarized light assembly 1 further comprising a light source 20 with a light transmission medium 28 for multiple light emitting sources 240 fixed into a device 200 forming a specific pattern of rows and columns of individual light emitting sources 240. The light emitting sources 240 are directed to reflect off the material and through the analyzer 50, 55. A polarizer 30, 33 may be assembled within device 200 for each or any combination or arrangement of the light emitting sources 240 to enable polarized light 22 to be emitted onto the surface of the material.

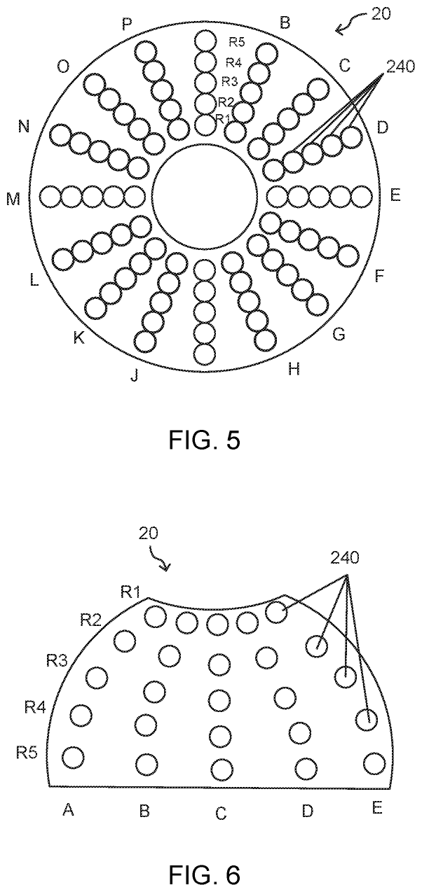

In embodiments of the polarized light assembly 1 the multiple light emitting sources 240, may be illuminated one at a time, in sequence, or simultaneously to achieve various angles of incidence on the material. Additionally, or alternatively, the wavelength, intensity, or both, of the light emitted from the light emitting sources 240 may be altered for one or more of the individual light emitting source 240. As an example in FIG. 5, the multiple light emitting sources 240 may be arranged in columns and rows, with representative columns A-P and representative rows R1-R5.

Additionally, or alternatively, another example of light rotation of the light source 20 would be to turn on and off representative rows R1-R5. The embodiments of the light source 20 show a certain number of columns, rows, and light emitting sources 240, but the light emitting source 240 may have any number of columns, rows, and lights 240. The lights 240 may be spread evenly or alternatively may be spread in unevenly along the light source 20. The angles and positions of the light subsets 200 may be even or uneven throughout the light source 20.

The Figures show five representative rows R1-R5 and sixteen columns A-P. However, it is contemplated the light source 20 may comprise any number of rows and columns. It is further contemplated that the rows and columns of light source 20 may vary in number of light emitting sources 240 in each row or column.

The polarized light assembly 1 may be combined with inputs or outputs to display the results of the testing or inspection of the materials. The results of the testing may be displayed on screens such as televisions, phones, or through paper outputs, or through any other means of conveying information.

Operating of the polarized light assembly 1 may be done manually or through code. Any code may be used. Additionally or alternatively, the polarized light assembly 1 may allow for zooming and panning of the material or materials. Movement of the material or materials being inspected as well as movement of the inspection tool in relation to the material or materials being inspected. This movement may be accomplished by the polarized light assembly 1 being attached to a moveable or immoveable arm, gantry rig, or frame that may otherwise be able to be moved along an axis of movement. While zooming or panning materials, the polarized light assembly 1 may be affixed to a moveable arm or otherwise able to be moved along the width, length, and/or height of a surface to conduct material inspection along a portion or the entirety of the surface. In so doing, a problem location may be found on the surface to warrant further evaluation. Alternatively, the polarized light assembly 1 may be handled and moved manually along a surface. Additionally or alternatively, the material could be moved under the objective a stationary mounted handheld device.

To operate the polarized light assembly 1, a user may use the following method of material inspection. A first step would be to identify an area of interest on a material. This identification may comprise defining or searching for an existing flaw, geometry, wear markings, or any other feature of interest on a material. Alternatively, the area of interest may be the entirety of the material.

The second step of the method of operation would be to select the appropriate objective for the field of view requirements. Depending on the size of the field of view, a different objective may be needed. The objective may be a single lens, a mirror, a combination thereof, or a combination of multiple optical elements. The objective determines the optical magnification and effective resolution of the image. For example, a higher magnification would be used for a smaller field of view and a higher resolution, while a lower magnification would be used for a larger field of view and a relatively lower resolution.

An optional third step would be to use a stand-off attachment to control focal distance. An alternative third step would be to use a manual control to control the focal distance. The fourth step would be to activate the camera within the analyzer 50.

Activating the camera would comprise delivering power to the camera and may comprise initiation of software to control the camera and capture, storage, and delivery of images. The software may be any code which works within the camera to perform the necessary steps.

The fifth step is to activate the light source 20. The light source 20 then illuminates the region of interest on the material. The light source 20 may be substantially as described above. The sixth step is to activate the rotator 33 & synchronize with camera within the analyzer 50. By synchronizing the two elements, this method ensures that the polarization field is matched to the analyzer 50. Light may be extinguished for each rotation angle.

The rotation angles may be at distinct intervals. One set of rotation angles may be at 0 degrees, 45 degrees, 90 degrees, and 135 degrees. Another set of rotation angles may be at 0 degrees, 90 degrees, 180 degrees, and 270 degrees. The rotation angles may be any set of angles which provide distinct views and images. By doing so, these images characterize the field of view across multiple response variables. Changing angle provides gross measurement of crystallographic state. Changing wavelengths provides finer resolution in orientation angle of crystals. One exemplary image set of four images may have a mix of wavelengths and angles, with a first wavelength, polarizer 30 at 0 degrees; first wavelength, polarizer 30 at 90 degrees; a second wavelength, polarizer 30 at 0 degrees; and 0 second wavelength, polarizer 30 at 90 degrees. Image capture may be obtained at any time during operation by the analyzer 50.

If there is another region of interest, the assembly 1 is moved to new region of interest and another image set is captured. Software may compare ratios between angles at each wavelength to known standards and determine orientation of specific grains or micro-texture regions. The steps above may be repeated.

Unless otherwise defined, all technical and scientific terms used herein have the same meaning as commonly understood by one of ordinary skill in the art to which the claimed subject matter belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise

It is noted that terms like “preferred,” and “commonly,” are not utilized herein to limit the scope of the appended claims or to imply that certain features are critical, essential, or even important to the structure or function of the claimed subject matter. Rather, these terms are merely intended to highlight alternative or additional features that may or may not be utilized in a particular embodiment

It is noted that the terms like “substantially” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue

Certain terminology is used in the disclosure for convenience only and is not limiting. The words “left”, “right”, “front”, “back”, “upper”, and “lower” designate directions in the drawings to which reference is made. The terminology includes the words noted above as well as derivatives thereof and words of similar import

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A portable material inspection device, comprising:
a light source;
a polarizer, and
an analyzer, wherein the light source emits light through the polarizer to a material and the light reaches the analyzer; and
the angle or position of the incident emitted light, either polarized or unpolarized is freely adjustable.

2. The portable material inspection device of claim 1, further comprising an external shell.

3. The portable material inspection device of claim 2, wherein the external shell is waterproof and/or dust resistant.

4. The portable material inspection device of claim 2, wherein the dimensions of the portable material inspection device are less than 7 inches by 5 inches by 2 inches.

5. The portable material inspection device of claim 4, wherein the portable material inspection device is affixed to an arm, gantry rig, frame, or other support structure.

6. A material inspection tool comprising:
a light source;
a polarizer, and
an analyzer, wherein the light source emits light through the polarizer to a material and the light reaches the analyzer; and
the light source rotates the direction of light emitted.

7. The material inspection tool of claim 6, wherein the light source comprises multiple lights.

8. The material inspection tool of claim 7, wherein the multiple lights are arranged in radial arrays.

9. The material inspection tool of claim 6, wherein the light source and polarizer are movable to multiple angles in relation to the material to be inspected.

10. The material inspection tool of claim 6, wherein the polarizer rotates while the light source emits light.

11. The portable material inspection device of claim 5, wherein the support structure moves across a surface while the portable material inspection device operates.

12. A device for characterizing material attributes based on the selective response of a material to specific wavelengths of polarized light of a plurality of wavelengths at one or more angles of incidence, comprising:
a light source;
a polarizer;
at least one rotator;
an objective,
and an analyzer.

13. The device of claim 12, wherein the analyzer further comprises a camera or other data capture device.

14. The device of claim 12, wherein the rotator is integrated with the polarizer.

15. The device of claim 12, wherein the rotator is liquid crystal.

16. The device of claim 12, wherein the rotator is integrated with the analyzer.

17. The device of claim 16, further comprising a second rotator integrated with the polarizer.

18. The portable material inspection device of claim 1, wherein the portable inspection device is configured to inspect metals, alloys, composites, wood, biological material, and/or isotropic materials.

19. The portable material inspection device of claim 2, wherein the external shell encapsulates only a portion of the portable material inspection device.

20. The portable material inspection device of claim 2, wherein the external shell is transparent.
